(19) United States
(12) Patent Application Publication
(10) Pub. No.: US 2024/0355234 A1
(43) Pub. Date: Oct. 24, 2024

(54) Discrete Chamber Climate Simulator

(71) Applicant: Amelia Technologies, Washington, DC, DC (US)

(72) Inventor: Peter Sykora, Washington, DC, DC (US)

(73) Assignee: Amelia Technologies, Washington, DC, DC (US)

(21) Appl. No.: 18/640,723

(22) Filed: Apr. 19, 2024

Related U.S. Application Data
(63) Continuation of application No. 63/497,508, filed on Apr. 21, 2023.

(51) Int. Cl. G09B 23/40

(52) U.S. Cl. CPC G09B 23/40

(57) ABSTRACT

Systems and methods for the controlled incubation of simulated environmental conditions in a cheap contained system. In many embodiments, variation on components, as well as ranging ultraviolet and visible wavelengths produce different, controlled, and observable outcomes of climate change simulations. Simulations of this type allows for learning at various levels of educational background.

### CROSS REFERENCE TO RELATED APPLICATIONS

The present application claims priority to and benefit from U.S. Provisional Application No. 63/497,508 filed Apr. 21, 2023, the entire contents of each of which are herein incorporated by reference.

### FEDERAL FUNDS STATEMENT

This invention was made with Government support under SBIR/STTR contract number R44ES036060. The Government has certain rights in this invention.

### TECHNICAL FIELD

Embodiments of the present invention relate to inducing noticeable changes to a simulated environment by adding stresses similar to those encountered by the environment by climate change. More particularly embodiments may allow for easily understandable observations for educating school children.

### PRIOR ART

### Background of the Invention

Climate change presents itself as an existential crisis for mankind. It is, however to appreciate the exact effects that these changes make on a small scale that then leads to the impacts that might appear in the news. Current education related to climate change is not widely accessible or easily digestible.

One major innovation of the technology is the approachable elements of the system, where using various easy to modulate changes within an easily discernible container allows the user to witness and observe real time change to the simulated environment. Induction of such small stress into the simulated environment presents easily understandable and observable changes.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a diagrammatic representation of an example of a composition according to an embodiment;

FIG. 2 is a diagrammatic representation of an example of a method for incubating a simulated environment according to an embodiment.

FIG. 3 is a diagrammatic representation of an example of a method for incubating a simulated environment according to an embodiment.

FIG. 4 is a diagrammatic representation of an example of a method for incubating a simulated environment according to an embodiment.

FIG. 5 is a pictorial representation of an example of a system incubating a simulated environment according to an embodiment.

### DETAILED DESCRIPTION

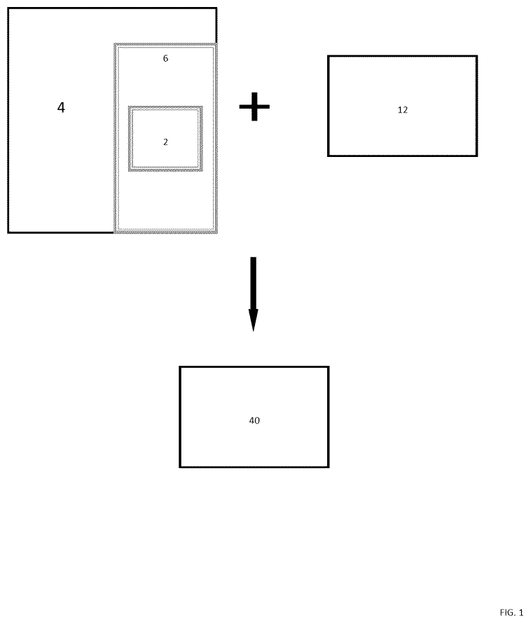

FIG. 1 represents a potential embodiment that includes a well plate 4 with a chamber 6. In some embodiments, up to six chambers 6 may be located on a well plate 4. This embodiment includes sample 2 placed in chamber 6. Within chamber 6, radiation 12 was added to well plate 4 to produce a measurable ecological manipulation 40.

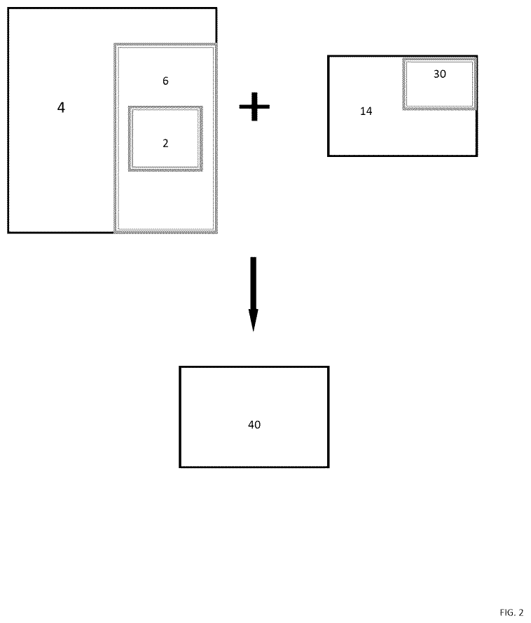

FIG. 2 represents a potential embodiment that includes a well plate 4 with a chamber 6. In some embodiments, up to six chambers 6 may be located on a well plate 4. This embodiment includes sample 2 placed in chamber 6. Within chamber 6, temperature 14 was added to well plate 4, perhaps utilizing thermal electrical conduction 30 to produce a measurable ecological manipulation 40.

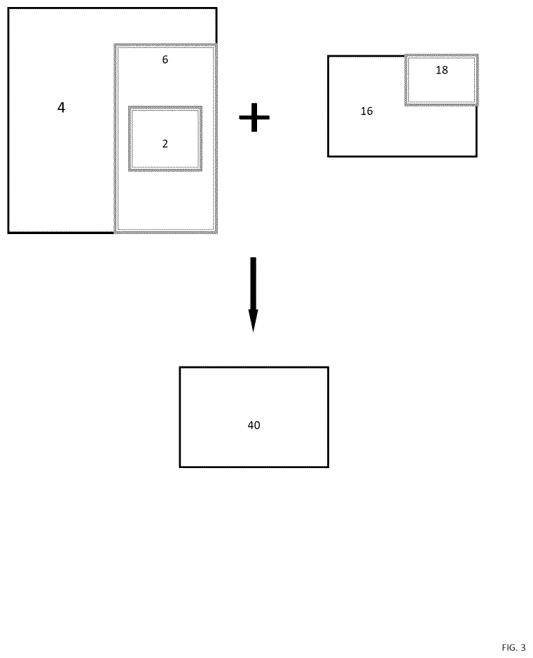

FIG. 3 represents a potential embodiment that includes a well plate 4 with a chamber 6. In some embodiments, up to six chambers 6 may be located on a well plate 4. This embodiment includes sample 2 placed in chamber 6. Within chamber 6, the addition of gas 16, usually carbon dioxide, through a tubing source 18 to well plate 4 to produce a measurable ecological manipulation 40.

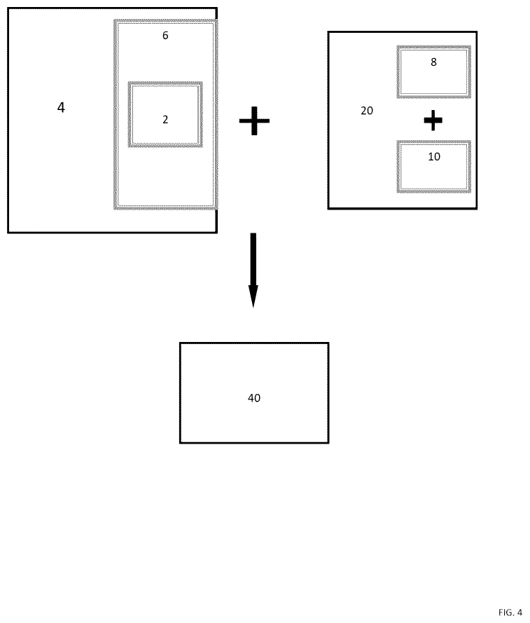

FIG. 4 represents a potential embodiment that includes a well plate 4 with a chamber 6. In some embodiments, up to six chambers 6 may be located on a well plate 4. This embodiment includes sample 2 placed in chamber 6. Within chamber 6, the addition of light variation component 20 to well plate 4, using light emitting diodes 8 or visible light intensity variation 10 there, will be a measurable ecological manipulation 40.

In many embodiments, the various additions in the four figures may be modulated to produce a method of interacting with sample 2 to create a measurable ecological manipulation 40. Each addition to the well plate 4 in the four figures might be included in these embodiments. These embodiments may include all four, three, two, or just one addition.

In one embodiment of the claimed invention, the necessary composite parts are gathered to control incubation, including stimulating ecological manipulation by providing temperature 14 changes, varying carbon dioxide gas 16 levels, varying visible light levels 10, and varying radiation levels 12.

In some embodiments, this sample 2 might be an environmental setting of interest or a biological specimen of interest.

One embodiment of the use of gas 16 through tubing source 18 might include gas exchange ports allowing gas expansion and exchange between chambers. These valves may be exchanged to allow for one-way or two-way gas exchange. Further embodiments may use tubing 18 with in-line filters to prevent contamination.

In many embodiments, independent simulated compartments experience different and varying conditions based on settings. In many embodiments, the settings of simulated compartments are modifiable with easily understandable inputs. Inputs in some embodiments are accessible to younger students.

Many embodiments will have a gas exchange system. The chamber gas exchange will be done through a port at the top of chamber 6. A nipple on the port will allow the user to attach short sections of tubing 18 to deliver gas, in many embodiments, likely carbon dioxide gas 16, to the bottom of chamber 6, if required.

Many units on the back will have six input ports that can be individually opened and closed. Low-pressure carbon dioxide gas 16 might be generated using a yeast/sugar mix in generic soda bottles connected to a low-tech distribution system.

Set-ups may provide additional carbon dioxide gas 16 to the atmosphere control component 24 for forty-eight hours; in other embodiments, a cartridge unit will be included as a stand-alone addition to the apparatus.

This unit could accept up to 4 screw-top 16g mini canisters of carbon dioxide gas 16. The canisters will be connected to a manifold system, sometimes used in planted aquariums, and four separate pressure mini regulators (one per canister).

In some situations, a carbon dioxide gas 16 diffuser might be connected to up to four units simultaneously. Each canister would maintain carbon dioxide gas 16 levels for at least seven days.

In many embodiments, there will also be a digital carbon dioxide gas 16 sensor to measure the output and be able to adjust carbon dioxide gas 16 levels.

Many embodiments involve utilizing well plates 4 with various chamber numbers and, within those chambers, providing independent simulated environments.

Each chamber 6, or in some embodiments chamber, can have a wide spectrum grow light emitting diode and UVB light emitting diode 8. Further, in some embodiments, an infrared capable light emitting diode 8 may also be introduced to model the greenhouse conditions more accurately on Earth. The UVB (280 nm) light emitting diode 8 has two functions: it allows users to do experiments focusing on the role of the ozone layer and DNA damage in human and environmental systems.

In many situations, in the absence of a sterile culture environment, UVB capable light emitting diodes 8 can be used to sterilize the chamber 6 surface and medium before inoculation with biologicals.

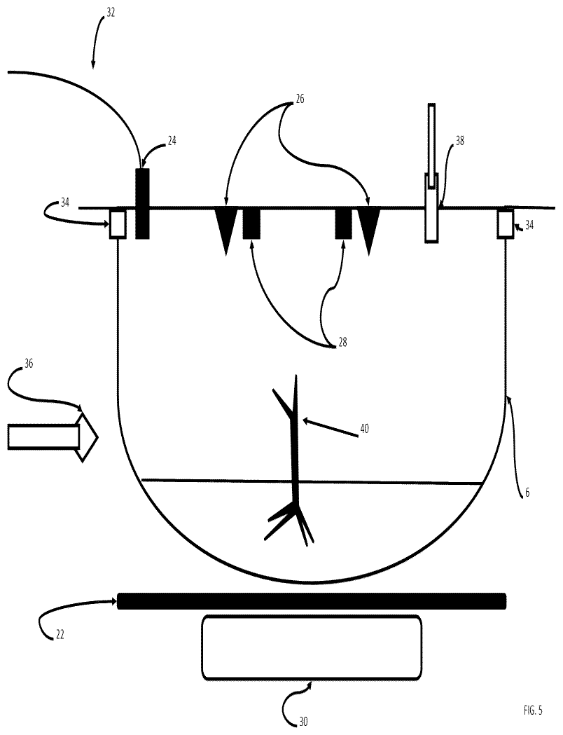

FIG. 5 is a pictorial representation of an embodiment of chamber 6 with various possible components.

In one embodiment, radiation exposure component 28 is included to regulate ultraviolet conditions and can be used to test measurable ecological manipulation 40. Other embodiments might consist of using the ultraviolet capable light emitting diode 8 to sterilize the independent simulated environment compartments within chamber 6.

A system will likely include light variation component 26. In some embodiments, this component may provide light levels 10 and possibly add to temperature 14.

In one embodiment, the light variation component 26 will completely mimic solar light spectrums on Earth. In others, the inclusion of infrared light emitting diodes might be used to simulate the greenhouse effect.

Atmosphere control component 24 will exist in many embodiments. This control component will likely control the flow of gas 16 into the chamber 6.

Another embodiment includes the inclusion of a temperature sensor 38 to prevent overheating. In further embodiments, the temperature sensor 38 is positioned to allow for experiments regarding temperature changes that affect environmental conditions. The sensor can be placed in the chamber “atmosphere” to facilitate the use of the system to track atmospheric temperature changes.

In other embodiments, a thermoelectric conductor (TEC) plate 30 is a solid-state source of generating very precise and localized changes in temperature. TEC plates have no moving parts, are cheap, and require no calibration or ongoing maintenance. They represent a significant advancement in heating technology and are currently used in research (PCR machines) and domestic applications (small drink fridges).

In another embodiment, a sensor port 36 might be included to facilitate more robust data collection.

An optic sensor might be included in some embodiments, such as a sensor that may allow measurement of light output through a liquid medium. This sensor is used to measure the optic density changes associated with culture growth.

Other embodiments include a sensor to measure the acidity level of independent simulated environments. In many embodiments, the levels of carbon dioxide gas 16 can vary.

In many iterations of the technology, a photodiode sensor will be in the sensor port 36. This light sensor will be used to measure the optic density changes associated with the growth of suspension culture, including algae and bacteria.

In many embodiments, six separate “ecosystems” exist in a disposable six-chamber 6 well plate 4 (90 mm×120 mm×20 mm). Each of the six chambers 6 may have all or some components.

A single seal 34, might seal each chamber 6 and prevent chamber-to-chamber contamination. In many embodiments, these will be removable, washable, and likely a silicon gasket.

Many embodiments may include an atmosphere variation component 24, usually with in-line filters. These valves are for one-way or two-way gas exchange and allow for the expansion of gases in the chambers associated with temperature changes.

In some embodiments, These ports can also be used to introduce carbon dioxide gas 16 into the chamber.

The current embodiments are advantageous as they require no maintenance or additional calibration. It can be used year after year, with the light emitting diode 8 having an estimated 30,000 hours of use.

The component hardware can be integrated into the existing school curriculum and be used in conjunction with standard classroom biotechnology equipment to expand the utility of existing equipment such as PCR, electrophoresis, and other generic science classroom equipment.

These stand-alone embodiments might be kits covering climate change experiments that have traditionally been too difficult to convert to an active educational format. They have a broad range of climate change issues, including global warming, algae blooms, solar damage, and water contamination.

In the proposed embodiments, it is possible to manipulate the “climate” in multiple chambers 6 or chambers separately and simultaneously. This variety allows users to directly observe the impact of small changes in climate on experimental organisms and biological materials.

In an embodiment, the system will have the physical characteristics of an external shell that might consist of a separate upper and lower section. The upper section, with most electronic components and touch screens, is slotting into the lower section with the TEC plates 30, power supply and some sensors. Slotting the upper into the lower section seals the previously inserted six chambered 6 well plate 4 (without lid), creating six separate chambers. The shells of both upper and lower sections might be cast or even 3D printed.

The silicon gasket seal 34 that is used to seal each of the chambers 6 may be cast as a one piece, the mold being 3D-printed.

In some embodiments, the light might be light emitting diodes 8, which have an output capable of wavelengths at 380-840 nm.

The light emitting diode 8 or light source might have a wide spectrum light output suitable for all stages of growth. This light emitting diode 8 may have low heat output because enclosed micro-growth applications have traditionally suffered from heat issues associated with the low efficiency of the light sources.

In most embodiments, each chamber will have a UVB capable light emitting diode 8, usually calibrated at 280 nm wavelength. This feature gives the unit an integrated sterilization capability.

Some embodiments might include additional lighting and control parameters added to each chamber, including an infra-red capable light emitting diode 8 and detector.

Many embodiments might have onboard thermal systems that use 6 individually controllable TEC plates 30. As in all PCR machines, the TEC plate 30 will likely be placed under thin aluminum sheets to dissipate heat more evenly in each chamber.

Chambers 6 allow for the settings to be four temperatures 20, 25, 30 and 40° C., with inter-chamber variability not greater than 10%.

Some embodiments will include an onboard wide-spectrum photodiode. This generic sensor has a detection spectrum of 500-1100 nm wavelength and would be used to measure the light emitting diode 8 output. The main application of this sensor is to measure the optic density of the liquid growth substrate. As the organisms grow in the chambers, they turn the media from clear to cloudy, changing the optical density and reducing the amount of light detected by the photodiode.

Many embodiments might include a user interface. In most embodiments, units might be controlled by USB port via input CSV file. Users select parameters such as temperature 14, on and off power designation, and duration. These parameters might be on a spreadsheet, and the unit is controlled by saving the settings and uploading them to the unit.

Other embodiments might include an integrated touchscreen with Wi-Fi and a USB port. This interface will allow users to see step-by-step instructions real-time data collection, and easily select from the pre-loaded parameters for automated experimental set-up.

A major advantage of the technology is the ability to grow a range of biological organisms in chambers 6. These biological samples 2 include bacteria, photosynthetic algae, and aquatic plants.

Studies have shown that elevated temperatures can alter pathogen survival, replication, and virulence, while changes in rainfall patterns can mobilize pathogens and overwhelm sanitation infrastructure.

Some embodiments may be used to create a bioremediation situation using environmental guidelines for wastewater sterilization. This utilization might include the removal of contaminants from simulated wastewater samples 2. As a result, the principles of ultraviolet sterilization, bioremediation, and environmental protection can be studied.

We claim:

1. A method of controlled incubation, including stimulating ecological manipulation by providing temperature changes, varying gas levels, varying visible light intensity, and varying levels of radiation.

2. The method as in claim 1, wherein the temperature change is produced through thermos electrical conduction.

3. The method as in claim 1, wherein the carbon dioxide gas variation is produced by tubing source.

4. The method as in claim 1, wherein the light wavelength range is 380 nanometers to 500 nanometers.

5. The method as in claim 1, wherein radiation level variation is produced by ultraviolet light emitting diodes.

6. A system comprising:
a temperature change component;
an atmosphere variation component;
visible light variation component and
a radiation exposure control component.

7. The system as in claim 6, wherein the temperature change is produced through thermos electrical conduction.

8. The system as in claim 6, atmosphere variation is produced by tubing source.

9. The system as in claim 6, wherein the light variation component is a wide spectrum light emitting diode.

10. The system as in claim 9, wherein the light wavelength range is 380 nanometers to 500 nanometers.

11. The system as in claim 6, wherein radiation level variation is produced by ultraviolet light emitting diodes.

12. The system as in claim 11, wherein the light emitting diode component emits light at a wavelength of 280 nanometers.

13. The system as in claim 11, wherein the light emitting diode component emits light at a wavelength of 350 nanometers.

14. A method of controlled incubation, including stimulating ecological manipulation:
providing a sample;
placing sample into well plate,
providing temperature changes,
varying carbon dioxide levels,
varying visible light levels,
varying levels of radiation; and
observing result.

15. The method as in claim 14, wherein well plate is removable.

16. The method as in claim 14, wherein well plate is variable in size up to 6 chambers.

17. The method as in claim 14, wherein each well plate contains a different sample in each chamber.

18. The method as in claim 14, wherein the temperature change is produced through thermos electrical conduction.

19. The method as in claim 14, carbon dioxide variation is produced by tubing source.

20. The method as in claim 14, wherein the light variation component is a wide spectrum light emitting diode.

21. The method as in claim 20, wherein the light wavelength range is 380 nanometers to 500 nanometers.

22. The method as in claim 14, wherein radiation level variation is produced by ultraviolet light emitting diodes.

23. The method as in claim 22, wherein the light emitting diode component emits light at a wavelength of 280 nanometers.
